(19) United States
(12) Patent Application Publication
(10) Pub. No.: US 2022/0291385 A1
(43) Pub. Date: Sep. 15, 2022

(54) DISTANCE MEASUREMENT SYSTEM AND ELECTRONIC APPARATUS

(71) Applicant: SONY SEMICONDUCTOR SOLUTIONS CORPORATION, KANAGAWA (JP)

(72) Inventor: MOTONARI HONDA, KANAGAWA (JP)

(21) Appl. No.: 17/636,134

(22) PCT Filed: Jul. 9, 2020
(86) PCT No.: PCT/JP2020/026887

§ 371 Date: Feb. 17, 2022

(30) Foreign Application Priority Data
Aug. 27, 2019 (JP) 2019-154498

(51) Int. Cl. G01S 17/89; G01S 7/481

(52) U.S. Cl. CPC G01S 17/89; G01S 7/4815; G01S 7/4817

(57) ABSTRACT

A distance measurement system according to the present disclosure includes: a surface emitting semiconductor laser that projects light of a predetermined pattern onto a subject; an event detection sensor that receives light reflected off the subject and detects, as an event, that a change in luminance of a pixel exceeds a predetermined threshold; and a controller that controls the surface emitting semiconductor laser and the event detection sensor. An arrangement of light sources of the surface emitting semiconductor laser is an array dot arrangement in which the light sources are two-dimensionally arranged in an array form. With two light sources that are adjacent in the array dot arrangement as a unit of driving, the controller drives the two light sources to be on at the same time in a period between respective times when the two light sources are driven to be on independently of each other.

### TECHNICAL FIELD

The present disclosure relates to a distance measurement system and an electronic apparatus.

### BACKGROUND ART

A technology of a structured light scheme that uses a dynamic projector and a dynamic vision camera has been proposed as a system for acquiring a three-dimensional (3D) image (depth information/information of a depth of a surface of an object) or measuring a distance to a subject (see PTL 1, for example). According to the structured light scheme, light having a pattern determined in advance is projected onto a measurement target/subject from the dynamic projector and the depth information/distance information is acquired by analyzing a degree of distortion of the pattern on the basis of a result of imaging by the dynamic vision camera.

PTL 1 discloses a technology that uses a vertical cavity surface emitting laser (VCSEL: Vertical Cavity Surface Emitting Laser) as the dynamic projector which is a light source, and uses an event detection sensor called a DVS (Dynamic Vision Sensor) as the dynamic vision camera which is a light receiving unit. The event detection sensor is a sensor detecting, as an event, that a change in luminance of a pixel which photoelectrically converts entering light exceeds a predetermined threshold.

### CITATION LIST

### Patent Literature

PTL 1: US 2019/0045173 A1

### SUMMARY OF THE INVENTION

### Problem to be Solved by the Invention

Incidentally, as an arrangement of light sources (so-called point light sources) of a vertical cavity surface emitting laser, a random dot arrangement is known which arranges the light sources (dots) in a specific arrangement with no repetition and has a feature in a spatial direction. However, in a case of the random dot arrangement, it is difficult to increase the number of the light sources while maintaining specificity of an arrangement pattern of the light sources for light source identification, and therefore it is not possible to increase a resolution of a distance image determined by the number of the light sources. From the resolution viewpoint, an array dot arrangement which two-dimensionally arranges the light sources in an array form (matrix form) at constant pitches is superior to the random dot arrangement as an arrangement of the light sources of the vertical cavity surface emitting laser. However, even in a case of the array dot arrangement, the resolution of the distance image is determined by the number of the light sources and therefore there is also a limit to increasing of the resolution.

Therefore, the present disclosure aims to provide a distance measurement system that makes it possible to increase a resolution of a distance image for obtaining distance information to a subject without increasing the number of light sources in an array dot arrangement of the light sources (dots), and an electronic apparatus including the distance measurement system.

### Means for Solving the Problem

A distance measurement system of the present disclosure to achieve the above-described object includes:

a surface emitting semiconductor laser that projects light of a predetermined pattern onto a subject;

an event detection sensor that receives light reflected off the subject and detects, as an event, that a change in luminance of a pixel exceeds a predetermined threshold; and

a controller that controls the surface emitting semiconductor laser and the event detection sensor.

An arrangement of light sources of the surface emitting semiconductor laser is an array dot arrangement in which the light sources are two-dimensionally arranged in an array form.

With two light sources that are adjacent in the array dot arrangement as a unit of driving, the controller drives the two light sources to be on at the same time in a period between respective times when the two light sources are driven to be on independently of each other.

Further, an electronic apparatus of the present disclosure to achieve the above-described object includes a distance measurement system having the above-described configuration.

### BRIEF DESCRIPTION OF THE DRAWINGS

FIG. 1A is a schematic diagram illustrating an example of a configuration of a distance measurement system according to an embodiment of the present disclosure, and FIG. 1B is a block diagram illustrating an example of a circuit configuration thereof.

FIG. 2A is a diagram illustrating a random dot arrangement of light sources of a vertical cavity surface emitting laser of the distance measurement system according to the embodiment of the present disclosure, and FIG. 2B is a diagram illustrating an array dot arrangement of the light sources of the vertical cavity surface emitting laser.

FIG. 3A is a diagram illustrating combinations of two light sources in the array dot arrangement, and FIG. 3B is a diagram describing driving of the light sources according to Example 1.

FIG. 4 is a diagram describing driving of the light sources according to Example 2.

FIG. 5 is a diagram describing driving of the light sources according to Example 3.

FIG. 6 is a block diagram illustrating an example of a configuration of an event detection sensor of the distance measurement system according to the embodiment of the present disclosure.

FIG. 7 is a circuit diagram illustrating a circuit configuration of a pixel according to Circuit Configuration Example 1.

FIG. 8 is a circuit diagram illustrating a circuit configuration of a pixel according to Circuit Configuration Example 2.

FIG. 9 is a circuit diagram illustrating a circuit configuration of a pixel according to Circuit Configuration Example 3.

FIG. 10 is a circuit diagram illustrating a circuit configuration of a pixel according to Circuit Configuration Example 4.

FIG. 11 is an external view of a smartphone according to a specific example of an electronic apparatus of the present disclosure from a front side.

### MODES FOR CARRYING OUT THE INVENTION

Hereinafter, modes for carrying out the technology of the present disclosure (hereinafter referred to as “embodiments”) are described in detail with reference to the drawings. The technology of the present disclosure is not limited to the embodiments. In the following description, the same components, or components having the same function are denoted by the same reference signs, and redundant description is omitted. It is to be noted that description is given in the following order.
1. General Description of Distance Measurement System and Electronic Apparatus of Present Disclosure
2. Distance Measurement System According to Embodiment
   2-1. System Configuration
   2-2. Vertical Cavity Surface Emitting Laser (VCSEL)
      2-2-1. Random Dot Arrangement
      2-2-2. Array Dot Arrangement
   2-3. Example 1 (An example in which an intensity peak is created at a middle position between two light sources)
   2-4. Example 2 (An example in which sensitivity adjustment of an event detection sensor is performed concurrently)
   2-5. Example 3 (An example in which, when driving two light sources at the same time, a peak position is moved while making light emission intensities of the two light sources different from each other to cause an intensity peak to be constant)
   2-6. Event Detection Sensor (DVS)
      2-6-1. Configuration Example of Event Detection Sensor
      2-6-2. Circuit Configuration Example of Pixel
         2-6-2-1. Circuit Configuration Example 1 (An example in which detection of an on-event and detection of an off-event are performed in a time divisional manner by using one comparator)
         2-6-2-2. Circuit Configuration Example 2 (An example in which detection of the on-event and detection of the off-event are performed concurrently by using two comparators)
         2-6-2-3. Circuit Configuration Example 3 (An example in which detection of only the on-event is performed by using one comparator)
         2-6-2-4. Circuit Configuration Example 4 (An example in which detection of only the off-event is performed by using one comparator)
3. Modification Example
4. Application Example
5. Electronic Apparatus of Present Disclosure (An example of a smartphone)
6. Possible Configurations of Present Disclosure

<General Description of Distance Measurement System and Electronic Apparatus of Present Disclosure>

In a distance measurement system and an electronic apparatus of the present disclosure, a controller may be configured to perform control to drive two light sources at the same light emission intensity. At this time, the controller is preferably configured to perform control to drive the two light sources to be on at the same time at a middle position in an interval between the two light sources.

In the distance measurement system and the electronic apparatus of the present disclosure including the preferred configurations described above, in a period in which the controller drives the two light sources to be on at the same time, the controller may be configured to perform control to reduce a sensitivity of the event detection sensor to be lower than a sensitivity when the light sources are on singly. Further, when the controller drives the light sources to be on singly after driving the two light sources to be on at the same time, the controller may be configured to perform control to increase the sensitivity of the event detection sensor. At this time, it is preferable that when the controller drives the light sources to be on singly after driving the two light sources to be on at the same time, the controller be configured to perform control to increase the sensitivity of the event detection sensor to the same sensitivity as that before the driving of the two light sources to be on at the same time.

Further, in the distance measurement system and the electronic apparatus of the present disclosure including the preferred configurations described above, the controller may be configured to perform control to drive the two light sources at different light emission intensities. At this time, it is preferable that the controller be configured to control the two light sources to cause an intensity peak to be constant.

Further, in the distance measurement system and the electronic apparatus of the present disclosure including the preferred configurations described above, the controller may be configured to control the two light sources to cause the intensity peak to move by predetermined amounts in the interval between the two light sources. At this time, it is preferable that the controller be configured to perform control to gradually reduce the light emission intensity of one of the two light source and, in synchronization therewith, to gradually increase the light emission intensity of the other.

Further, in the distance measurement system and the electronic apparatus of the present disclosure including the preferred configurations described above, the two light sources may be configured to be adjacent in a row direction, a column direction, or a diagonal direction in the array dot arrangement. Further, the surface emitting semiconductor laser is preferably a vertical cavity surface emitting laser. In addition, the vertical cavity surface emitting laser may be configured to project light of a predetermined pattern onto a subject.

<Distance Measurement System According to Embodiment>

The distance measurement system according to the embodiment of the present disclosure is a system for measuring a distance to a subject by using a technology of a structured light scheme. Further, the distance measurement system according to the embodiment of the present disclosure is also usable as a system for acquiring a three-dimensional (3D) image, in which case the system may be referred to as a three-dimensional image acquisition system. According to the structured light scheme, coordinates of a point image and which light source (point light source) the point image has been projected from are identified by pattern matching to thereby perform distance measurement.

[System Configuration]

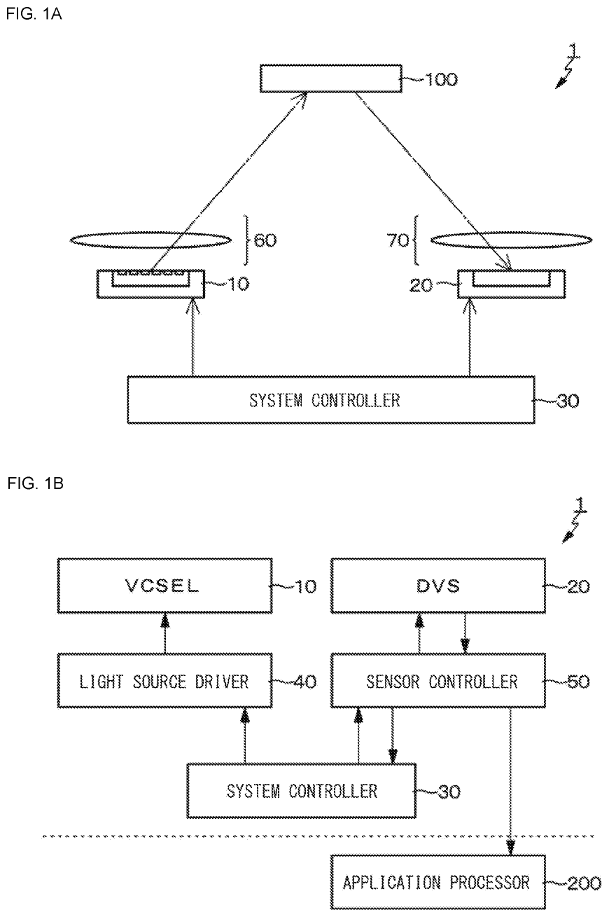

FIG. 1A is a schematic diagram illustrating an example of a configuration of the distance measurement system according to the embodiment of the present disclosure, and FIG. 1B is a block diagram illustrating an example of a circuit configuration thereof.

The distance measurement system 1 according to the present embodiment uses a surface emitting semiconductor laser, e.g., a vertical cavity surface emitting laser (VCSEL) 10 as a light source unit, and uses an event detection sensor 20 called a DVS as a light receiving unit. The vertical cavity surface emitting laser (VCSEL) 10 projects a light of a predetermined pattern onto a subject. The distance measurement system 1 according to the present embodiment includes, in addition to the vertical cavity surface emitting laser 10 and the event detection sensor 20, a system controller 30, a light source driver 40, a sensor controller 50, a light-source-side optical system 60, and a camera-side optical system 70.

Details of the vertical cavity surface emitting laser (VCSEL) 10 and the event detection sensor (DVS) 20 will be described later. The system controller 30 includes a processor (CPU), for example. The system controller 30 drives the vertical cavity surface emitting laser 10 via the light source driver 40, and drives the event detection sensor 20 via the sensor controller 50. More specifically, the system controller 30 controls the vertical cavity surface emitting laser 10 and the event detection sensor 20 in synchronization with each other, for example. However, it is not essential to control the vertical cavity surface emitting laser 10 and the event detection sensor 20 in synchronization with each other.

In the distance measurement system 1 according to the present embodiment having the above-described configuration, light of a pattern determined in advance that is emitted from the vertical cavity surface emitting laser 10 is projected onto a subject (a measurement target) 100 through the light-source-side optical system 40. The projected light is reflected off the subject 100. Then, the light reflected off the subject 100 enters the event detection sensor 20 through the camera-side optical system 70. The event detection sensor 20 receives the light reflected off the subject 100 and detects, as an event, that a change in luminance of a pixel exceeds a predetermined threshold. Event information detected by the event detection sensor 20 is supplied to an application processor 200 outside the distance measurement system 1. The application processor 200 performs predetermined processing on the event information detected by the event detection sensor 20.

[Vertical Cavity Surface Emitting Laser (VCSEL)]

(Random Dot Arrangement)

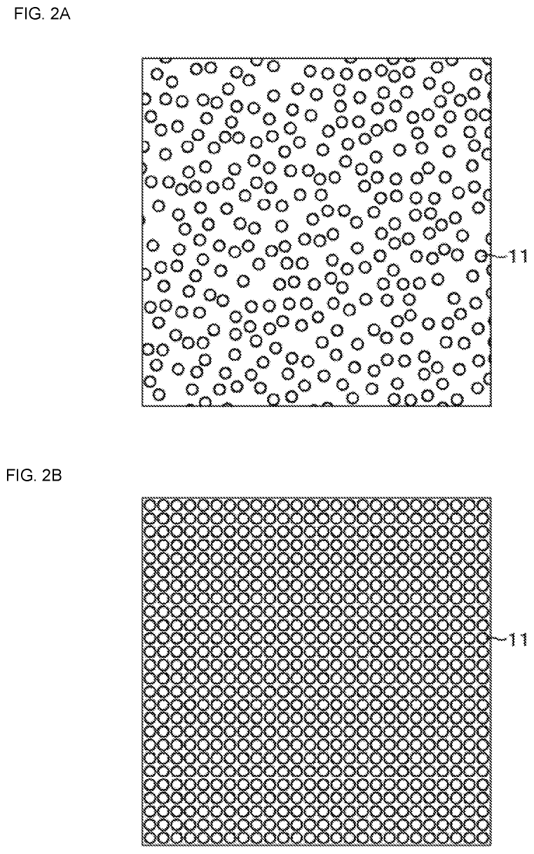

According to the structured light scheme, pattern matching in consideration of an affine transformation is necessary to identify the coordinates of a point image and which light source (point light source) the point image has been projected from. In order to enable pattern matching in consideration of the affine transformation, for arrangement of light sources 11 of the vertical cavity surface emitting laser 10, a so-called random dot arrangement is employed in which, as illustrated in FIG. 2A, the light sources 11 are arranged in a specific arrangement with no repetition and with a feature in a spatial direction.

However, in a case of the random dot arrangement, it is difficult to increase the number of the light sources 11 while maintaining the specificity of the arrangement pattern of the light sources 11 for light source identification. Therefore, it is not possible to increase a resolution of a distance image that is determined by the number of the light sources 11. Here, the “distance image” refers to an image for obtaining distance information to the subject.

(Array Dot Arrangement)

Accordingly, the distance measurement system 1 according to the present embodiment employs, for arrangement of the light sources 11 of the vertical cavity surface emitting laser 10, a so-called array dot arrangement in which, as illustrated in FIG. 2B, the light sources 11 are two-dimensionally arranged in an array form (matrix form) at constant pitches. With the distance measurement system 1 according to the present embodiment including a combination of the vertical cavity surface emitting layer 10 and the event detection sensor 20, which one of the light sources 11 an image has been projected from is easily identifiable by sequentially turning on the light sources 11 of the vertical cavity surface emitting layer 10 and referencing a time stamp (time information) of an event recorded by the event detection sensor 20, without necessitating randomly arranging the light sources 11.

In a case of the array dot arrangement, it is possible to make the number of the light sources 11 larger than that in the case of the random dot arrangement, and therefore it is possible to increase the resolution of the distance image determined by the number of the light sources (dots) 11. The distance measurement system 1 according to the present embodiment makes it possible to further increase the resolution of the distance image relative to the resolution determined by the number of the light sources 11 by driving the light sources 11 of the vertical cavity surface emitting laser 10 of the array dot arrangement in a devised way and providing a feature also in a time-axis direction.

The following will describe specific examples of driving of the light sources 11 for increasing the resolution of the distance image without increasing the number of the light sources in the array dot arrangement of the light sources.

### Example 1

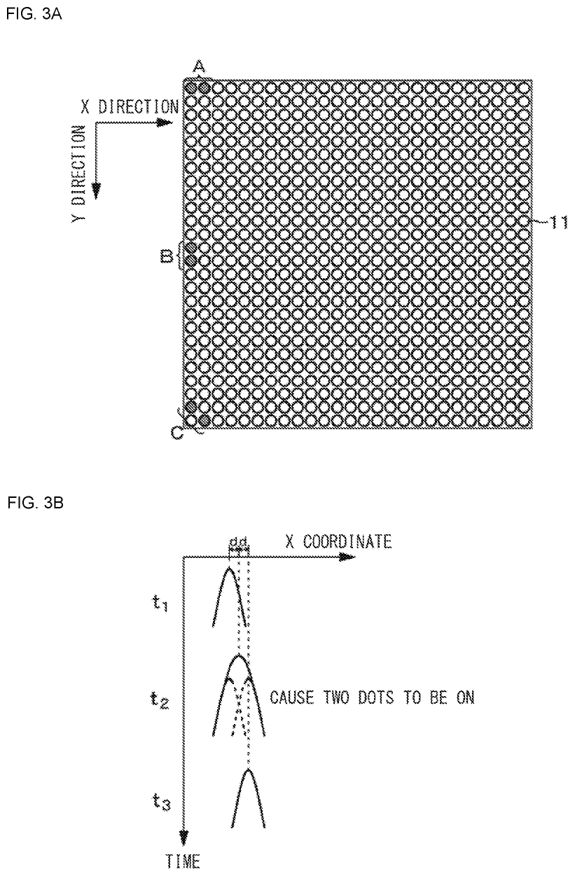

In driving the light sources 11 in the array dot arrangement in the vertical cavity surface emitting laser 10, two light sources 11, 11 that are adjacent in the array dot arrangement are defined as a unit of driving. Examples of a combination of the two adjacent light sources 11, 11 include, as illustrated in FIG. 3A, a combination A of two light sources 11, 11 that are adjacent in a row direction (an X direction), a combination B of two light sources 11, 11 that are adjacent in a column direction (a Y direction), and a combination C of two light sources 11, 11 that are adjacent in a diagonal direction.

A description will be given of Example 1 with reference to a case of driving the light sources 11 in the combination A of two light sources 11, 11 that are adjacent in the row direction, by way of example. FIG. 3B is a diagram describing driving of the light sources according to Example 1. The driving of the light sources 11 is performed by the light source driver 40 under control by the system controller 30. The same applies to each example described later in this regard.

Example 1 is an example of driving the two adjacent light sources 11, 11 to be on at the same time and creating an intensity peak at a middle position in an interval between respective times when the light sources 11 are driven to be on independently of each other. Here, the “middle position” is intended to include not only a case of being an exactly middle position but also a case of being a substantially middle position, and the presence of various variations caused by design or manufacturing is permissible. Further, in Example 1, the two light sources 11, 11 are set to the same light emission intensity. Here, “the same” is intended to include not only a case of being exactly the same but also a case of being substantially the same, and the presence of various variations caused by design or manufacturing is permissible.

Of the two light sources 11, 11 adjacent in the row direction (the X direction), a first light source (the left side in FIG. 3A) 11 is driven to be on (to emit light) at a time t₁, then the two light sources 11, 11 are driven to be on (two dots are driven to be on) at the same time at a time t₂, and then the second light source (the right side in FIG. 3A) 11 is driven to be on at a time t₃. In other words, under the control by the system controller 30, the two light sources 11, 11 are driven to be on at the same time (time t₂) in a period between the time t₁ and the time t₃ at which the two light sources 11, 11 are driven to be on independently of each other, in other words, in an interval between the two light sources 11, 11, preferably at a middle position in the interval.

Here, the time t₂ at which the two light sources 11, 11 are driven to be on at the same time is set to a time midway between the time t₁ and the time t₂, in other words, a time falling at a middle position between a position of an intensity peak of the first light source 11 and a position of an intensity peak of the second light source 11 in the row direction (the X coordinate). As a result, a distance between the peak position when the first light source 11 is driven to be on and the peak position when the two dots are driven to be on and a distance between the peak position when the two dots are driven to be on and the peak position when the second light source 11 is driven to be on become the same distance d.

As described above, in Example 1, with two adjacent light sources 11, 11 as a unit of driving, an operation of driving the two light sources to be on at the same time (in this example, an operation of driving the two light sources 11, 11 to be on at the same time in the period between the respective times when the two light sources 11, 11 are driven to be on independently of each other) is performed in addition to an operation of driving the two light sources 11, 11 to be on independently of each other. This makes it possible to create an intensity peak at a position (in this example, the middle position in the interval between the two light sources 11, 11) different from that in a case where the two light sources 11, 11 are driven to be on independently of each other. This driving makes it possible to provide a feature not only in the spatial direction but also in the time-axis direction, thus making it possible to increase the resolution of the distance image for obtaining distance information to the subject without increasing the number of the light sources 11 while maintaining the specificity of the arrangement pattern of the light sources 11 for light source identification.

It is to be noted that in Example 1, the two light sources 11, 11 to be a unit of driving are set to the same light emission intensity; however, one or both of the two light sources 11, 11 may be adjustable in terms of light emission intensity.

Further, for Example 1, the description has been given of the case of the combination A of two light sources 11, 11 by way of example; however, basically, also in a case of the combination B or the combination C, performing the driving in a similar manner to that in the case of Example 1 makes it possible to increase the resolution of the distance image without increasing the number of the light sources 11 while maintaining the specificity of the arrangement pattern of the light sources 11 for light source identification. The same applies to each example described later in this regard.

### Example 2

Example 2 is an example in which sensitivity adjustment of the event detection sensor (DVS) 20 is performed concurrently in the case of the combination A of two light sources 11, 11. Here, for the sake of convenience in explanation, of the two light sources adjacent in the row direction (the X direction), a first light source 11 (the left side in FIG. 3A) will be described as a light source 1, and a second light source 11 (the right side in FIG. 3A) will be described as a light source 2.

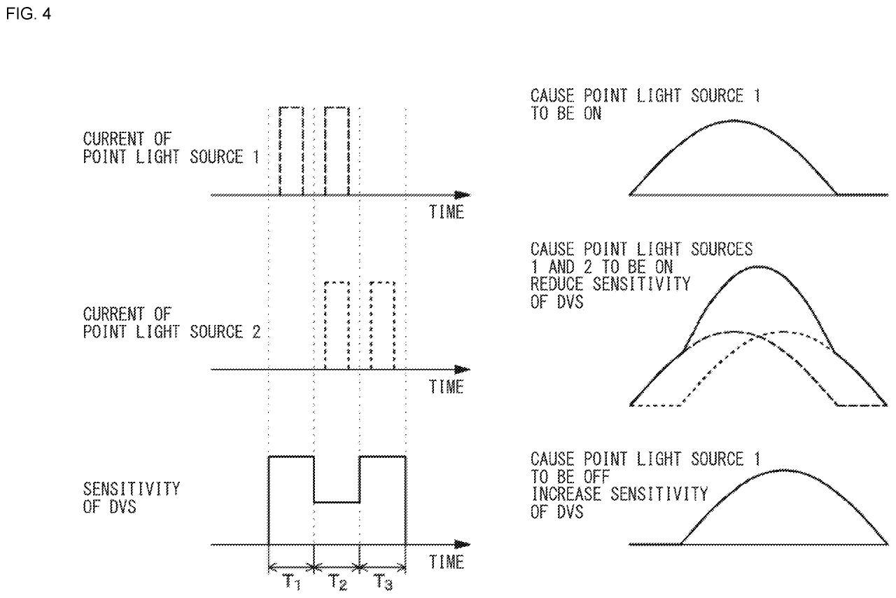

FIG. 4 is a diagram describing driving of the light sources according to Example 2. In FIG. 4, a current of the light source 1 is illustrated in broken lines, and a current of the light source 2 is illustrated in dotted lines. Further, the sensitivity of the event detection sensor (DVS) 20 is illustrated in solid lines. In Example 2 also, as in Example 1, the two light sources 1 and 2 are set to the same light emission intensity; however, one or both of the two light sources 1 and 2 may be adjustable in terms of light emission intensity.

In Example 2, the light source 1 is driven to be on in a period T₁, and then the light source 2 is driven to be on in a period T₂. As a result, in the period T₂, the light source 1 and the light source 2 are on at the same time. Due to the light source 1 and the light source 2 being on at the same time, an intensity peak in the period T₂ becomes higher than that in a case where the light source 1 is on singly (this is the same as in the case of the driving example 1).

Then, in the period T₂, control is performed to reduce the sensitivity of the event detection sensor (DVS) 20 to be lower than the sensitivity when the light source 1 is on singly (the period T₁). The control to adjust the sensitivity of the event detection sensor 20 is performed under the control by the system controller 30 (see FIG. 1). Here, reducing the sensitivity of the event detection sensor 20 means that the event detection sensor 20 responds when a larger amount of light enters.

Next, in a period T₃, the light source 1 is driven to be off and the sensitivity of the event detection sensor 20 is increased. At this time, the sensitivity of the event detection sensor 20 is preferably returned to the same sensitivity as that before the driving of the light source 1 and the light source 2 to be on at the same time, that is, the same sensitivity as that at the time of driving the light source 1 to be on singly (the period T₁). Here, “the same sensitivity” is intended to include not only a case of being exactly the same sensitivity but also a case of being substantially the same sensitivity, and the presence of various variations caused by design or manufacturing is permissible.

As described above, according to Example 2, in the period T₂ in which the two light sources 1 and 2 are driven to be on at the same time, the sensitivity of the event detection sensor 20 is reduced to be lower than that at the time of driving the light source 1 to be on singly. This makes it possible to create three reaction positions for the event detection sensor 20 through driving the two light sources 1 and 2 to be on. This driving makes it possible to provide a feature not only in the spatial direction but also in the time-axis direction, thus making it possible to increase the resolution of the distance image for obtaining distance information to the subject without increasing the number of the light sources 11 while maintaining the specificity of the arrangement pattern of the light sources 11 for light source identification.

### Example 3

Example 3 is an example in which in the case of the combination A of two light sources 11, 11 and when the two light sources 11, 11 are driven at the same time, a peak position is moved (shifted) while making light emission intensities of the two light sources 11, 11 different from each other to cause the intensity peak to be constant. Here, the “intensity peak to be constant” is intended to include not only a case of the intensity peak being exactly constant but also a case of the intensity peak being substantially constant, and the presence of various variations caused by design or manufacturing is permissible.

In Example 3 also, for the sake of convenience in explanation, a first light source 11 (the left side in FIG. 3A) of the two light sources 11, 11 adjacent in the row direction will be described as a light source 1, and a second light source 11 (the left side in FIG. 3A) will be described as a light source 2.

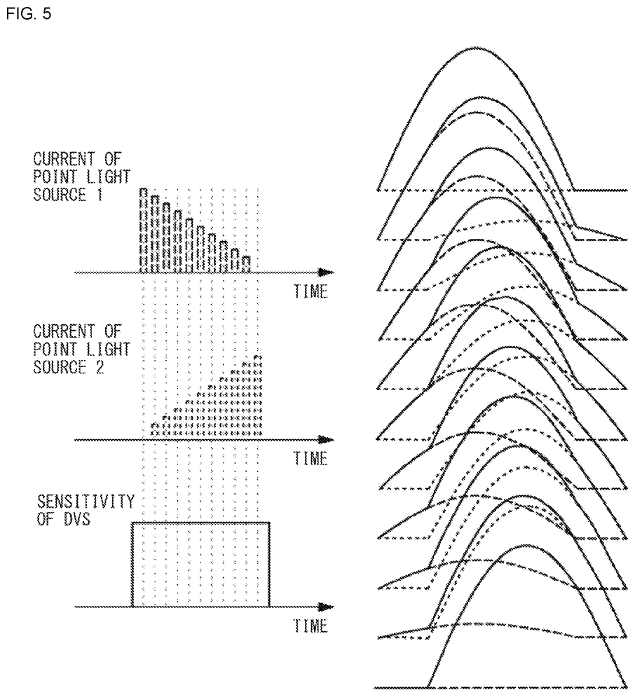

FIG. 5 is a diagram describing driving of the light sources according to Example 3. In FIG. 5, a current of the light source 1 is illustrated in broken lines, and a current of the light source 2 is illustrated in dotted lines. Further, intensity waveforms when the light sources 1 and 2 are on singly and when the light sources 1 and 2 are on at the same time are illustrated in solid lines. In a case of Example 3, the sensitivity of the event detection sensor (DVS) 20 is set to be constant.

In Example 3, in a period from after turning on (after turning off) the light source 1 singly to before turning on the light source 2 singly, driving is performed, for example, to gradually reduce the light emission intensity of the light source 1 and, in synchronization therewith, to gradually increase the light emission intensity of the light source 2 to cause the intensity peak when the light sources 1 and 2 are on at the same time to be constant. By performing this driving, it is possible to move (shift) the peak position by predetermined amounts (on a little-by-little basis) with the intensity peak kept constant.

As described above, according to Example 3, control is performed to cause the peak position to move by predetermined amounts while adjusting the light emission intensities of both of the light sources 1 and 2 to cause the intensity peak when the light sources 1 and 2 are on at the same time to be constant. This makes it possible to create more reaction positions for the event detection sensor 20 through driving the two light sources 1 and 2 to be on. This driving makes it possible to provide a feature not only in the spatial direction but also in the time-axis direction, thus making it possible to increase the resolution of the distance image for obtaining distance information to the subject without increasing the number of the light sources 11 while maintaining the specificity of the arrangement pattern of the light sources 11 for light source identification.

It is to be noted that for Example 1 to Example 3, while a case has been exemplified where, in the case of the combination A of two light sources 11, 11, the light source 1 is driven to be on singly, then the light source 1 and the light source 2 are driven to be on at the same time, and then the light source 2 is driven to be on singly, similar driving is repeated thereafter. In other words, driving into an on state is repeated in such a manner that the light source 2 is driven to be on singly, then the light source 2 and a light source 3 are driven to be on at the same time, then the light source 3 is driven to be on singly, then a light source 4 and a light source 4 are driven to be on at the same time, then the light source 4 . . . .

Further, which one of the combination A, the combination B, and the combination C of two adjacent light sources 11, 11 is to be employed may be freely chosen. Alternatively, any two or more of the combinations may be combined. Employing the combination A allows for increasing the resolution in the row direction (horizontal direction); employing the combination B allows for increasing the resolution in the column direction (vertical direction); and employing the combination C allows for increasing the resolution in the diagonal direction.

[Event Detection Sensor (DVS)]

Next, the event detection sensor 20 will be described.

(Configuration Example of Event Detection Sensor)

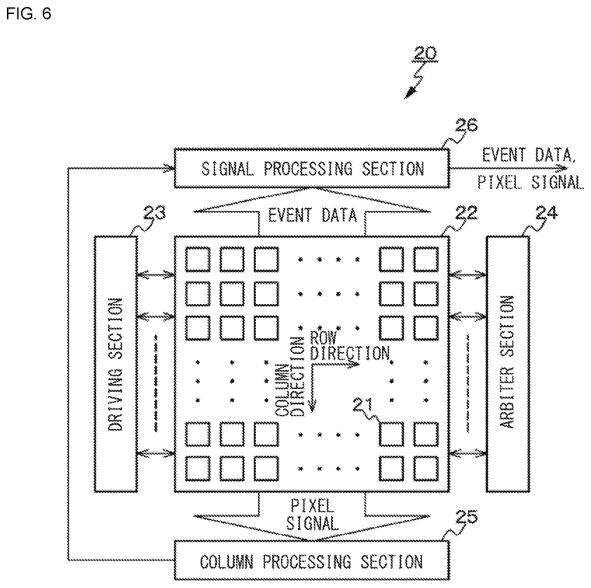

FIG. 6 is a block diagram illustrating an example of a configuration of the event detection sensor 20 in the distance measurement system 1 according to the embodiment of the present disclosure having the above-described configuration.

The event detection sensor 20 according to this example includes a pixel array section 22 including a plurality of pixels 21 two-dimensionally arranged in a matrix form (array form). The plurality of pixels 21 each generates and outputs, as a pixel signal, an analog signal of a voltage corresponding to a photocurrent as an electric signal generated by photoelectric conversion. In addition, the plurality of pixels 21 each detects the presence or absence of an event on the basis of whether or not a change exceeding a predetermined threshold has occurred in the photocurrent corresponding to a luminance of entering light. In other words, the plurality of pixels 21 each detects, as an event, that a change in luminance exceeds the predetermined threshold.

The event detection sensor 20 includes, in addition to the pixel array section 22, a driving section 23, an arbiter section (arbitration section) 24, a column processing section 25, and a signal processing section 26, as peripheral circuit sections for the pixel array section 22.

Upon detection of an event, the plurality of pixels 21 each outputs to the arbiter section 24 a request for output of event data indicating the occurrence of the event. Then, in a case where a response indicating approval for output of the event data is received from the arbiter section 24, the plurality of pixels 21 each outputs the event data to the driving section 23 and the signal processing section 26. In addition, the pixel 21 that has detected the event outputs an analog pixel signal generated by photoelectric conversion to the column processing section 25.

The driving section 23 drives each pixel 21 in the pixel array section 22. For example, the driving section 23 drives the pixel 21 that has detected an event and outputted the event data, and causes the analog pixel signal of that pixel 21 to be outputted to the column processing section 25.

The arbiter section 24 arbitrates requests for output of event data supplied from the respective plurality of pixels 21 and transmits responses based on the arbitration results (approval/disapproval for output of the event data) and reset signals for resetting detection of the events to the pixels 21.

The column processing section 25 includes, for example, an analog-to-digital conversion section including an assembly of analog-to-digital converters provided for each pixel column of the pixel array section 22. Examples of the analog-to-digital converter include a single-slope analog-to-digital converter, a successive approximation analog-to-digital converter, and a delta-sigma modulation (ΔΣmodulation) analog-to-digital converter.

At the column processing section 25, processing is performed for each pixel column of the pixel array section 22 to convert the analog pixel signals outputted from the pixels 21 in the column into digital signals. It is also possible for the column processing section 25 to subject the digitized pixel signals to CDS (Correlated Double Sampling) processing.

The signal processing section 26 executes predetermined signal processing on the digitized pixel signals supplied from the column processing section 25 and the event data outputted from the pixel array section 22, and outputs the event data and the pixel signals having undergone the signal processing.

As described above, a change in the photocurrent generated at the pixel 21 can be regarded as a change in light amount (change in luminance) of light entering the pixel 21. Therefore, an event can also be said to be a change in light amount (change in luminance) at the pixel 21 exceeding a predetermined threshold. The event data indicating the occurrence of the event includes at least position information, such as coordinates, indicating the position of the pixel 21 where the change in light amount, as the event, has occurred. The event data can include a polarity of the change in light amount, in addition to the position information.

Regarding the sequence of event data outputted from the pixels 21 at timings when events occurred, the event data can be said to implicitly include time information indicating a relative time when the event occurred, as long as an interval between pieces of the event data remains in the same state as when the events occurred.

However, the time information implicitly included in the event data is lost if the interval between the pieces of the event data no longer remains in the same state as when the events occurred, due to a reason such as recordation of the event data in a memory. To cope with this, the signal processing section 26 adds time information, such as a time stamp, indicating a relative time at which the event occurred, to the event data before the interval between pieces of the event data no longer remains in the same state as when the events occurred.

(Circuit Configuration Example of Pixel)

Next, specific circuit configuration examples of the pixel 21 will be described. The pixel 21 has an event detection function of detecting, as an event, that a change in luminance exceeds a predetermined threshold.

The pixel 21 detects the presence or absence of the occurrence of an event on the basis of whether or not an amount of change of the photocurrent exceeds a predetermined threshold. The events include, for example, an on-event indicating that the amount of change of the photocurrent exceeds an upper threshold and an off-event indicating that the amount of change thereof falls below a lower threshold. In addition, the event data (event information) indicating the occurrence of the event includes one bit representing a result of detection of the on-event and one bit representing a result of detection of the off-event. It is to be noted that the pixel 21 may also be configured to have a function of detecting only the on-event, or may also be configured to have a function of detecting only the off-event.

<<Circuit Configuration Example 1>>

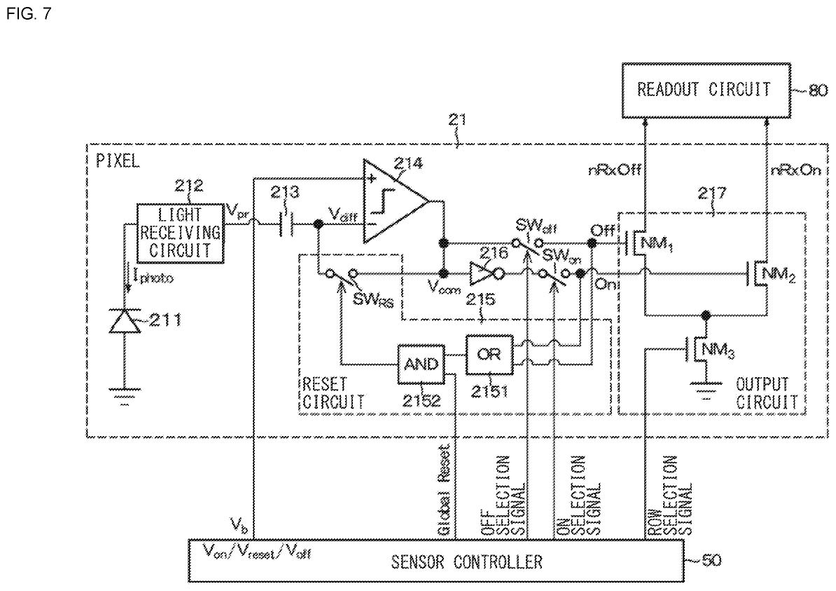

Circuit Configuration Example 1 is an example of performing detection of the on-event and detection of the off-event in a time divisional manner by using one comparator. A circuit diagram of the pixel 21 according to Circuit Configuration Example 1 is illustrated in FIG. 7. The pixel 21 according to Circuit Configuration Example 1 has a circuit configuration including a light receiving element (photoelectric conversion element) 211, a light receiving circuit 212, a memory capacity 213, a comparator 214, a reset circuit 215, an inverter 216, and an output circuit 217. The pixel 21 detects the on-event and the off-event under the control by the sensor controller 50.

The light receiving element 211 has a first electrode (anode electrode) coupled to an input end of the light receiving circuit 212, and a second electrode (cathode electrode) coupled to a ground node which is a reference potential node, and photoelectrically converts entering light to generate electric charge of an electric charge amount corresponding to the intensity (light amount) of the light. Further, the light receiving element 211 converts the generated electric charge into a photocurrent Iₚₕₒₜₒ.

The light receiving circuit 212 converts the photocurrent Iₚₕₒₜₒ corresponding to the intensity (light amount) of the light detected by the light receiving element 211 into a voltage Vₚᵣ. Here, a relationship of the voltage Vₚᵣ with the intensity of the light is generally a logarithmic relationship. In other words, the light receiving circuit 212 converts the photocurrent Iₚₕₒₜₒ corresponding to the intensity of the light illuminating a light receiving surface of the light receiving element 211 into the voltage Vₚᵣ which is a logarithmic function. However, the relationship between the photocurrent Iₚₕₒₜₒ and the voltage Vₚᵣ is not limited to the logarithmic relationship.

The voltage Vₚᵣ corresponding to the photocurrent Iₚₕₒₜₒ outputted from the light receiving circuit 212 passes through the memory capacity 213 and thereafter becomes an inverting (−) input which is a first input to the comparator 214 as a voltage V_{diff}. The comparator 214 generally includes differential pair transistors. The comparator 214 receives a threshold voltage V_{b} supplied from the sensor controller 50 as a non-inverting (+) input which is a second input, and performs detection of the on-event and detection of the off-event in a time divisional manner. Further, after detection of the on-event/off-event, the pixel 21 is reset by the reset circuit 215.

The sensor controller 50 outputs, as the threshold voltage V_{b}, a voltage Vₒₙ at a stage of detecting the on-event, a voltage V_{off} at a stage of detecting the off-event, and a voltage Vᵣₑₛₑₜ at a stage of performing a reset, in a time divisional manner. The voltage Vᵣₑₛₑₜ is set to a value between the voltage Vₒₙ and the voltage V_{off}, preferably to a middle value between the voltage Vₒₙ and the voltage V_{off}. Here, the “middle value” is intended to include not only a case of being an exactly middle value but also a case of being a substantially middle value, and the presence of various variations caused by design or manufacturing is permissible.

Further, the sensor controller 50 outputs, to the pixel 21, an On selection signal at the stage of detecting the on-event, an Off selection signal at the stage of detecting the off-event, and a global reset signal at the stage of performing the reset. The On selection signal is supplied to a selection switch SWₒₙ provided between the inverter 216 and the output circuit 217, as a control signal thereto. The Off selection signal is supplied to a selection switch SW_{Off} provided between the comparator 214 and the output circuit 217, as a control signal thereto.

At the stage of detecting the on-event, the comparator 214 compares the voltage Vₒₙ and the voltage V_{diff} and, in a case where the voltage V_{diff} exceeds the voltage Vₒₙ, the comparator 214 outputs on-event information On indicating that the amount of change of the photocurrent Iₚₕₒₜₒ exceeds the upper threshold, as a comparison result. The on-event information On is inverted by the inverter 216 and thereafter supplied to the output circuit 217 through the selection switch SWₒₙ.

At the stage of detecting the off-event, the comparator 214 compares the voltage V_{off} and the voltage V_{diff} and, in a case where the voltage V_{diff} falls below the voltage V_{off}, the comparator 214 outputs off-event information Off indicating that the amount of change of the photocurrent Iₚₕₒₜₒ falls below the lower threshold, as a comparison result. The off-event information Off is supplied to the output circuit 217 through the selection switch SW_{off}.

The reset circuit 215 has a configuration including a reset switch SW_{RS}, a 2-input OR circuit 2151, and a 2-input AND circuit 2152. The reset switch SW_{RS} is coupled between an inverting (−) input terminal and an output terminal of the comparator 214, and selectively establishes a short circuit between the inverting input terminal and the output terminal by coming into an on (closed) state.

The OR circuit 2151 receives the on-event information On passing through the selection switch SWₒₙ and the off-event information Off passing through the selection switch SW_{off} as two inputs. The AND circuit 2152 receives an output signal of the OR circuit 2151 as one input, and the global reset signal supplied from the sensor controller 50 as another input, and brings the reset switch SW_{RS} into the on (closed) state in a case where one of the on-event information On and the off-event information Off is detected and the global reset signal is in an active state.

In such a manner, in response to an output signal of the AND circuit 2152 coming into an active state, the reset switch SW_{RS} establishes a short circuit between the inverting input terminal and the output terminal of the comparator 214, and performs a global reset on the pixel 21. A reset operation is thereby performed only on the pixel 21 in which an event has been detected.

The output circuit 217 has a configuration including an off-event output transistor NM₁, an on-event output transistor NM₂, and a current source transistor NM₃. The off-event output transistor NM₁ has a memory (not illustrated) for holding the off-event information Off at a gate section thereof. The memory includes a gate stray capacitance of the off-event output transistor NM₁.

As with the off-event output transistor NM₁, the on-event output transistor NM₂ has a memory (not illustrated) for holding the on-event information On at a gate section thereof. The memory includes a gate stray capacitance of the on-event output transistor NM₂.

At a readout stage, the off-event information Off held in the memory of the off-event output transistor NM₁ and the on-event information On held in the memory of the on-event output transistor NM₂ are transferred to a readout circuit 80 through an output line nRxOff and an output line nRxOn for each pixel row of the pixel array section 22 upon supply of a row selection signal from the sensor controller 50 to a gate electrode of the current source transistor NM₃. The readout circuit 80 is a circuit provided in the signal processing section 26 (see FIG. 6), for example.

As described above, the pixel 21 according to Circuit Configuration Example 1 is configured to have the event detection function of performing detection of the on-event and detection of the off-event in a time divisional manner by using the one comparator 214 under the control by the sensor controller 50.

<<Circuit Configuration Example 2>>

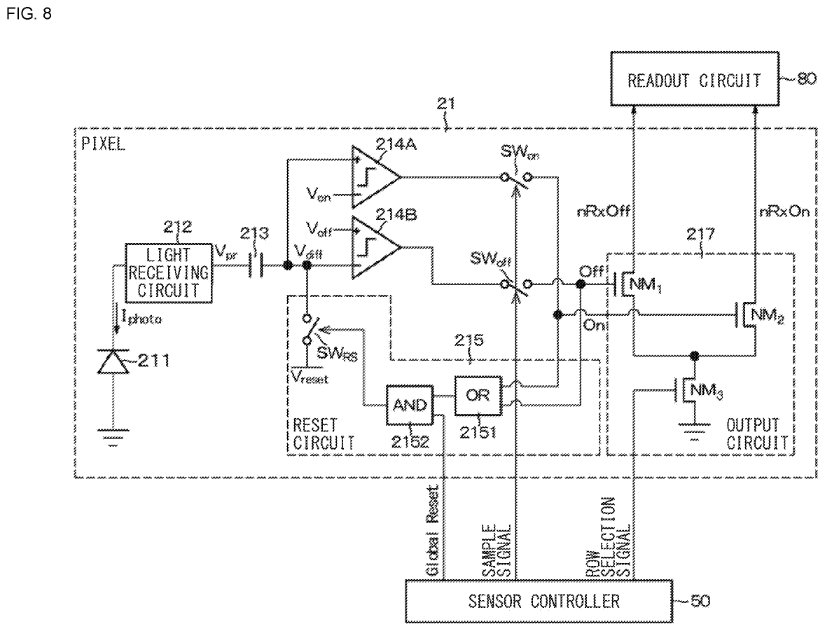

Circuit Configuration Example 2 is an example of performing detection of the on-event and detection of the off-event concurrently (at the same time) by using two comparators. A circuit diagram of the pixel 21 according to Circuit Configuration Example 2 is illustrated in FIG. 8.

As illustrated in FIG. 8, the pixel 21 according to Circuit Configuration Example 2 has a configuration including a comparator 214A for detecting the on-event and a comparator 214B for detecting the off-event. Thus, by performing event detection using the two comparators 214A and 214B, it is possible to perform an operation of detecting the on-event and an operation of detecting the off-event concurrently. As a result, it is possible to achieve faster operations for the operations of detecting the on-event and the off-event.

The comparator 214A for on-event detection generally includes differential pair transistors. The comparator 214A receives the voltage V_{diff} corresponding to the photocurrent Iₚₕₒₜₒ as a non-inverting (+) input which is a first input, and the voltage Vₒₙ as the threshold voltage V_{b} as an inverting (−) input which is a second input, and outputs the on-event information On as a result of comparison of the two. The comparator 214B for off-event detection also generally includes differential pair transistors. The comparator 214B receives the voltage V_{diff} corresponding to the photocurrent Iₚₕₒₜₒ as an inverting input which is a first input, and the voltage V_{off} as the threshold voltage V_{b} as a non-inverting input which is a second input, and outputs the off-event information Off as a result of comparison of the two.

The selection switch SWₒₙ is coupled between an output terminal of the comparator 214A and a gate electrode of the on-event output transistor NM₂ of the output circuit 217. The selection switch SW_{off} is coupled between an output terminal of the comparator 214B and a gate electrode of the off-event output transistor NM₁ of the output circuit 217. The selection switch SWₒₙ and the selection switch SW_{off} are subjected to on (close)/off (open) control by sample signals outputted from the sensor controller 50.

The on-event information On which is the comparison result of the comparator 214A is held in the memory of the gate section of the on-event output transistor NM₂ via the selection switch SWₒₙ. The memory for holding the on-event information On includes the gate stray capacitance of the on-event output transistor NM₂. The on-event Off which is the comparison result of the comparator 214B is held in the memory of the gate section of the off-event output transistor NM₁ via the selection switch SW_{off}. The memory for holding the on-event Off includes the gate stray capacitance of the off-event output transistor NM₁.

The on-event information On held in the memory of the on-event output transistor NM₂ and the off-event information Off held in the memory of the off-event output transistor NM₁ are transferred to the readout circuit 80 through the output line nRxOn and the output line nRxOff for each pixel row of the pixel array section 22 upon supply of the row selection signal from the sensor controller 50 to the gate electrode of the current source transistor NM₃.

As described above, the pixel 21 according to Circuit Configuration Example 2 is configured to have the event detection function of performing detection of the on-event and detection of the off-event concurrently (at the same time) by using the two comparators 214A and 214B under the control by the sensor controller 50.

<<Circuit Configuration Example 3>>

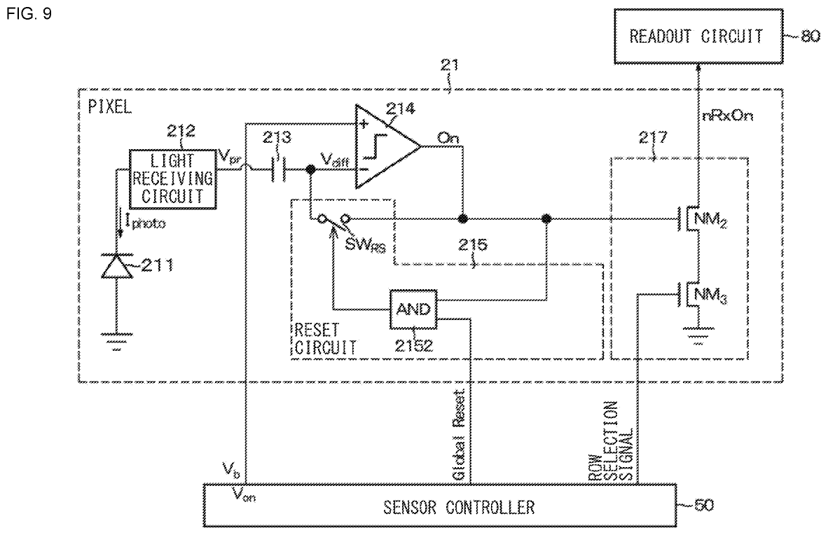

Circuit Configuration Example 3 is an example of performing detection of only the on-event. A circuit diagram of the pixel 21 according to Circuit Configuration Example 3 is illustrated in FIG. 9.

The pixel 21 according to Circuit Configuration Example 3 includes one comparator 214. The comparator 214 receives the voltage V_{diff} corresponding to the photocurrent Iₚₕₒₜₒ as the inverting (−) input which is the first input, and the voltage Vₒₙ supplied as the threshold voltage V_{b} from the sensor controller 50 as the non-inverting (+) input which is the second input, and compares the two to thereby output the on-event information On as a comparison result. Here, by using N-type transistors as the differential pair transistors to be included in the comparator 214, it is possible to make it unnecessary to provide the inverter 216 used in Circuit Configuration Example 1 (see FIG. 7).

The on-event information On which is the comparison result of the comparator 214 is held in the memory of the gate section of the on-event output transistor NM₂. The memory for holding the on-event information On includes the gate stray capacitance of the on-event output transistor NM₂. The on-event information On held in the memory of the on-event output transistor NM₂ is transferred to the readout circuit 80 through the output line nRxOn for each pixel row of the pixel array section 22 upon supply of the row selection signal from the sensor controller 50 to the gate electrode of the current source transistor NM₃.

As described above, the pixel 21 according to Circuit Configuration Example 3 is configured to have the event detection function of performing detection for only the on-event information On by using the one comparator 214 under the control by the sensor controller 50.

<<Circuit Configuration Example 4>>

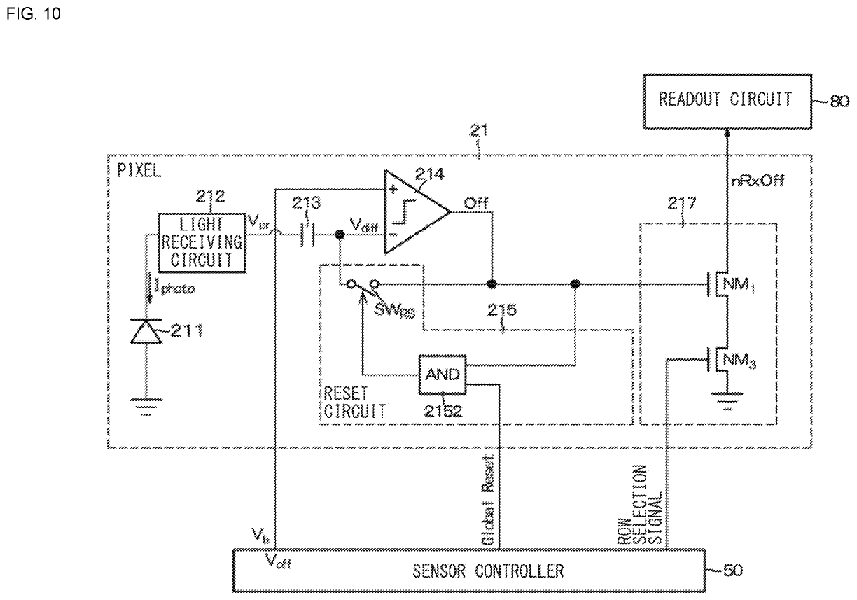

Circuit Configuration Example 4 is an example of performing detection of only the off-event. A circuit diagram of the pixel 21 according to Circuit Configuration Example 4 is illustrated in FIG. 10.

The pixel 21 according to Circuit Configuration Example 4 includes one comparator 214. The comparator 214 receives the voltage V_{diff} corresponding to the photocurrent Iₚₕₒₜₒ as the inverting (−) input which is the first input, and the voltage V_{off} supplied as the threshold voltage V_{b} from the sensor controller 50 as the non-inverting (+) input which is the second input, and compares the two to thereby output the off-event information Off as a comparison result. As the differential pair transistors to be included in the comparator 214, P-type transistors are usable.

The off-event information Off which is the comparison result of the comparator 214 is held in the memory of the gate section of the off-event output transistor NM₁. The memory for holding the off-event information Off includes the gate stray capacitance of the off-event output transistor NM₁. The off-event information Off held in the memory of the off-event output transistor NM₁ is transferred to the readout circuit 80 through the output line nRxOff for each pixel row of the pixel array section 22 upon supply of the row selection signal from the sensor controller 50 to the gate electrode of the current source transistor NM₃.

As described above, the pixel 21 according to Circuit Configuration Example 4 is configured to have the event detection function of performing detection for only the off-event information Off by using the one comparator 214 under the control by the sensor controller 50. It is to be noted that in the circuit configuration in FIG. 10, the reset switch SWᵣₛ is controlled by the output signal of the AND circuit 2152; however, the reset switch SWᵣₛ may be configured to be controlled directly by the global reset signal.

### Modification Example

While the technology of the present disclosure has been described above on the basis of the preferred embodiments, the technology of the present disclosure is not limited to the embodiments. The configuration and structure of the distance measurement system described in the foregoing embodiments are illustrative, and are modifiable on an as-needed basis.

### Application Example

The distance measurement system of the present disclosure described above has a variety of uses. Examples of the variety of uses include apparatuses and the like listed below.
Apparatuses for traffic use, including: onboard sensors that shoot images of the front, back, surroundings, inside, and the like of an automobile for purposes including safe driving, such as automatic stop, and recognition of the driver's state; monitoring cameras that monitor traveling vehicles and roads; and distance measurement sensors that measure vehicle-to-vehicle distances and the like
Apparatuses for use in home electrical appliances, including televisions, refrigerators, and air conditioners to shoot images of the user's gesture and bring the appliances into operation in accordance with the gesture Apparatuses for security use, including monitoring cameras for crime prevention and cameras for individual authentication

<Electronic Apparatus of Present Disclosure>

The distance measurement system of the present disclosure described above is usable, for example, as a three-dimensional image acquisition system (a face authentication system) to be mounted on various electronic apparatuses having a face authentication function. Examples of the electronic apparatus having the face authentication function include mobile apparatuses, including smartphones, tablets, personal computers, and the like. However, the electronic apparatuses in which the distance measurement system of the present disclosure is usable are not limited to the mobile apparatuses.

[Smartphone]

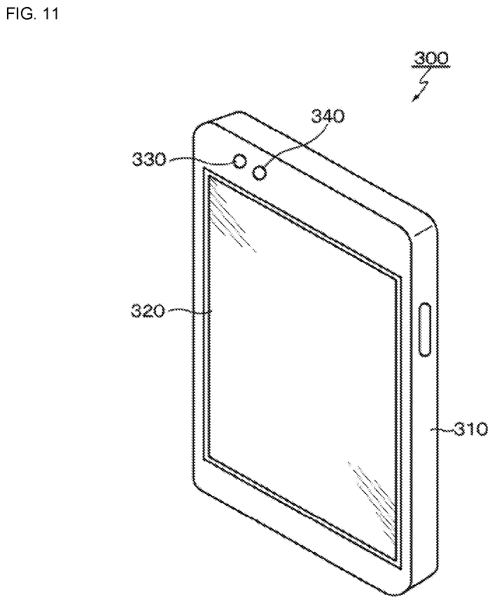

Here, a smartphone is exemplified as a specific example of an electronic apparatus of the present disclosure in which the distance measurement system of the present disclosure is usable. FIG. 11 is an external view of the smartphone according to the specific example of the electronic apparatus of the present disclosure from the front side.

The smartphone 300 according to this specific example includes a display unit 320 on the front side of a housing 310. Further, the smartphone 300 includes a light emitting unit 330 and a light receiving unit 340 at an upper portion of the housing 310 on the front side. It is to be noted that an arrangement example of the light emitting unit 330 and the light receiving unit 340 illustrated in FIG. 11 is one example, and this arrangement example is not limitative.

In the smartphone 300 which is an example of the mobile apparatus having the above-described configuration, the light source (the vertical cavity surface emitting laser 10) in the distance measurement system 1 according to the embodiment described above is usable as the light emitting unit 330, and the event detection sensor 20 is usable as the light receiving unit 340. In other words, the smartphone 300 according to this specific example is fabricated by using the distance measurement system 1 according to the embodiment described above as the three-dimensional image acquisition system.

The distance measurement system 1 according to the embodiment described above makes it possible to increase the resolution of the distance image without increasing the number of the light sources in the array dot arrangement of the light sources. It is therefore possible for the smartphone 300 according to this specific example to have a highly accurate face authentication function through the use of the distance measurement system 1 according to the embodiment described above as the three-dimensional image acquisition system (face authentication system).

<Possible Configurations of Present Disclosure>

It is to be noted that the present disclosure may also have the following configurations.

<<A. Distance Measurement System>>

[A-1] A distance measurement system including:

a surface emitting semiconductor laser that projects light of a predetermined pattern onto a subject;

an event detection sensor that receives light reflected off the subject and detects, as an event, that a change in luminance of a pixel exceeds a predetermined threshold; and

a controller that controls the surface emitting semiconductor laser and the event detection sensor, in which

an arrangement of light sources of the surface emitting semiconductor laser is an array dot arrangement in which the light sources are two-dimensionally arranged in an array form, and

with two light sources that are adjacent in the array dot arrangement as a unit of driving, the controller drives the two light sources to be on at the same time in a period between respective times when the two light sources are driven to be on independently of each other.

[A-2] The distance measurement system according to [A-1], in which the controller performs control to drive the two light sources at the same light emission intensity.

[A-3] The distance measurement system according to [A-2], in which the controller performs control to drive the two light sources to be on at the same time at a middle position in an interval between the two light sources.

[A-4] The distance measurement system according to [A-2] or [A-3], in which, in the period in which the controller drives the two light sources to be on at the same time, the controller performs control to reduce a sensitivity of the event detection sensor to be lower than a sensitivity when the light sources are on singly.

[A-5] The distance measurement system according to [A-4], in which when the controller drives the light sources to be on singly after driving the two light sources to be on at the same time, the controller performs control to increase the sensitivity of the event detection sensor.

[A-6] The distance measurement system according to [A-5], in which when the controller drives the light sources to be on singly after driving the two light sources to be on at the same time, the controller performs control to increase the sensitivity of the event detection sensor to the same sensitivity as that before the driving of the two light sources to be on at the same time.

[A-7] The distance measurement system according to [A-1], in which the controller performs control to drive the two light sources at different light emission intensities.

[A-8] The distance measurement system according to [A-7], in which the controller controls the two light sources to cause an intensity peak to be constant.

[A-9] The distance measurement system according to [A-8], in which the controller controls the two light sources to cause the intensity peak to move by predetermined amounts in the interval between the two light sources.

[A-10] The distance measurement system according to [A-9], in which the controller performs control to gradually reduce a light emission intensity of one of the two light source and, in synchronization therewith, to gradually increase a light emission intensity of the other.

[A-11] The distance measurement system according to any one of [A-1] to [A-10], in which the two light sources are adjacent in a row direction, a column direction, or a diagonal direction in the array dot arrangement.

[A-12] The distance measurement system according to any one of [A-1] to [A-11], in which the surface emitting semiconductor laser is a vertical cavity surface emitting laser.

<<B. Electronic Apparatus>>

[B-1] An electronic apparatus including

a distance measurement system including:
a surface emitting semiconductor laser that projects light of a predetermined pattern onto a subject;
an event detection sensor that receives light reflected off the subject and detects, as an event, that a change in luminance of a pixel exceeds a predetermined threshold; and
a controller that controls the surface emitting semiconductor laser and the event detection sensor, in which

an arrangement of light sources of the surface emitting semiconductor laser is an array dot arrangement in which the light sources are two-dimensionally arranged in an array form, and

with two light sources that are adjacent in the array dot arrangement as a unit of driving, the controller drives the two light sources to be on at the same time in a period between respective times when the two light sources are driven to be on independently of each other.

[B-2] The electronic apparatus according to [B-1], in which the controller performs control to drive the two light sources at the same light emission intensity.

[B-3] The electronic apparatus according to [B-2], in which the controller performs control to drive the two light sources to be on at the same time at a middle position in an interval between the two light sources.

[B-4] The electronic apparatus according to [B-2] or [B-3], in which, in the period in which the controller drives the two light sources to be on at the same time, the controller performs control to reduce a sensitivity of the event detection sensor to be lower than a sensitivity when the light sources are on singly.

[B-5] The electronic apparatus according to [B-4], in which when the controller drives the light sources to be on singly after driving the two light sources to be on at the same time, the controller performs control to increase the sensitivity of the event detection sensor.

[B-6] The electronic apparatus according to [B-5], in which when the controller drives the light sources to be on singly after driving the two light sources to be on at the same time, the controller performs control to increase the sensitivity of the event detection sensor to the same sensitivity as that before the driving of the two light sources to be on at the same time.

[B-7] The electronic apparatus according to [B-1], in which the controller performs control to drive the two light sources at different light emission intensities.

[B-8] The electronic apparatus according to [B-7], in which the controller controls the two light sources to cause an intensity peak to be constant.

[B-9] The electronic apparatus according to [B-8], in which the controller controls the two light sources to cause the intensity peak to move by predetermined amounts in the interval between the two light sources.

[B-10] The electronic apparatus according to [B-9], in which the controller performs control to gradually reduce a light emission intensity of one of the two light source and, in synchronization therewith, to gradually increase a light emission intensity of the other.

[B-11] The electronic apparatus according to any one of [B-1] to [B-10], in which the two light sources are adjacent in a row direction, a column direction, or a diagonal direction in the array dot arrangement.

[B-12] The electronic apparatus according to any one of [B-1] to [B-11], in which the surface emitting semiconductor laser is a vertical cavity surface emitting laser.

### REFERENCE SIGNS LIST

1 . . . distance measurement system, 10 . . . vertical cavity surface emitting laser (VCSEL), 11 . . . light source (point light source), 20 . . . event detection sensor (DVS), 21 . . . pixel, 22 . . . pixel array section, 23 . . . driving section, 24 . . . arbiter section, 25 . . . column processing section, 26 . . . signal processing section, 30 . . . system controller, 40 . . . light source driver, 50 . . . sensor controller, 60 . . . light-source-side optical system, 70 . . . camera-side optical system, 100 . . . subject, 200 . . . application processor

1. A distance measurement system comprising:
a surface emitting semiconductor laser that projects light onto a subject;
an event detection sensor that receives light reflected off the subject and detects, as an event, that a change in luminance of a pixel exceeds a predetermined threshold; and
a controller that controls the surface emitting semiconductor laser and the event detection sensor, wherein
an arrangement of light sources of the surface emitting semiconductor laser is an array dot arrangement in which the light sources are two-dimensionally arranged in an array form, and
with two light sources that are adjacent in the array dot arrangement as a unit of driving, the controller performs an operation of driving the two light sources to be on at a same time, in addition to an operation of driving the two light sources to be on independently of each other.

2. The distance measurement system according to claim 1, wherein the controller performs control to drive the two light sources at a same light emission intensity.

3. The distance measurement system according to claim 2, wherein the controller performs control to drive the two light sources to be on at the same time at a middle position in an interval between the two light sources.

4. The distance measurement system according to claim 2, wherein, in a period in which the controller drives the two light sources to be on at the same time, the controller performs control to reduce a sensitivity of the event detection sensor to be lower than a sensitivity when the light sources are on singly.

5. The distance measurement system according to claim 4, wherein when the controller drives the light sources to be on singly after driving the two light sources to be on at the same time, the controller performs control to increase the sensitivity of the event detection sensor.

6. The distance measurement system according to claim 5, wherein when the controller drives the light sources to be on singly after driving the two light sources to be on at the same time, the controller performs control to increase the sensitivity of the event detection sensor to a same sensitivity as that before the driving of the two light sources to be on at the same time.

7. The distance measurement system according to claim 1, wherein the controller performs control to drive the two light sources at different light emission intensities.

8. The distance measurement system according to claim 7, wherein the controller controls the two light sources to cause an intensity peak to be constant.

9. The distance measurement system according to claim 8, wherein the controller controls the two light sources to cause the intensity peak to move by predetermined amounts in the interval between the two light sources.

10. The distance measurement system according to claim 9, wherein the controller performs control to gradually reduce a light emission intensity of one of the two light source and, in synchronization therewith, to gradually increase a light emission intensity of another.

11. The distance measurement system according to claim 1, wherein the two light sources are adjacent in a row direction, a column direction, or a diagonal direction in the array dot arrangement.

12. The distance measurement system according to claim 1, wherein the surface emitting semiconductor laser is a vertical cavity surface emitting laser.

13. The distance measurement system according to claim 12, wherein the vertical cavity surface emitting laser projects light of a predetermined pattern onto the subject.

14. An electronic apparatus comprising
a distance measurement system including:
a surface emitting semiconductor laser that projects light onto a subject;
an event detection sensor that receives light reflected off the subject and detects, as an event, that a change in luminance of a pixel exceeds a predetermined threshold; and
a controller that controls the surface emitting semiconductor laser and the event detection sensor, wherein
an arrangement of light sources of the surface emitting semiconductor laser is an array dot arrangement in which the light sources are two-dimensionally arranged in an array form, and
with two light sources that are adjacent in the array dot arrangement as a unit of driving, the controller performs an operation of driving the two light sources to be on at a same time, in addition to an operation of driving the two light sources to be on independently of each other.
